(19) United States
(12) Patent Application Publication
(10) Pub. No.: US 2011/0289833 A1
(43) Pub. Date: Dec. 1, 2011

(54) PROTECTIVE COLD FRAME FOR PLANTS

(76) Inventors: James R. Lohse, Bellingham, WA (US); Zackary Marr, Everson, WA (US)

(21) Appl. No.: 12/788,646

(22) Filed: May 27, 2010

(51) Int. Cl. A01G 13/02

(52) U.S. Cl. 47/2; 47/20.1

(57) ABSTRACT

Disclosed herein is a plant-protecting device which is commonly known as a protective cold frame. While this description seems to indicate a frame-like device, the described device is intended to refer not only to the frame but also to a wind and thermal protective covering generally configured to hold heat therein to protect a plant therein from cold, wind, and the combination. In general, the disclosed device comprises a plurality of rod members that may be bendable, which are inserted into a coupler at the apex of the dome-shaped frame to provide a support structure for a cylindrical covering to be placed thereupon.

### BACKGROUND OF THE DISCLOSURE

a) Field of the Disclosure

This disclosure relates to the field of gardening or farming, wherein a protective covering is provided for plants to protect them from wind, cold, heavy rain, and/or other negative elements.

### SUMMARY OF THE DISCLOSURE

Disclosed herein is a frame and covering apparatus to protect plants from cold in several embodiments. The apparatus comprising: a plurality of at least three rod members each having a first longitudinal end configured to engage the ground around a plant to be protected and a second end; a coupling device operably configured to engage and receive each of the second ends of the plurality of rod members; the coupling device further having a central opening substantially orthogonal to the second ends of the plurality of rod members; wherein the plurality of rod members form a dome shaped frame when attached to the coupling device and engaged into the ground; a central stake having a first end operatively to engage the ground and a median portion passing through the central opening of the coupling device; a polymeric cylindrical covering having a first end which is open to allow access to the interior of the cylindrical covering; wherein the first end of the cylindrical covering is configured to fit over the dome outline; and wherein the cylindrical covering comprises a second end, longitudinally opposed to the first end, wherein the second end is configured to be gathered together and thus substantially conform the cylindrical covering to the dome shaped frame.

The apparatus as disclosed may further comprise a plurality of ground-engaging stakes configured to couple to the first ends of the rod members and fixedly and removably engage the ground. In one form, the apparatus further comprises at least three foot members operably configured to couple the first ends of the rod members to the ground engaging stakes.

In one form, the apparatus further comprises a plurality of side tie elements, wherein a plurality of attachment points are provided on the cylindrical covering between the first end and the second end, and wherein the side tie elements are operably configured to attach the cylindrical covering to the rod members at each of the attachment points. The apparatus may further comprise at least one of outer ground engaging stake and a guy line having a first end coupled to the attachment points of the apparatus and a second end coupled to the outer ground-engaging stakes.

The apparatus may be formed wherein the covering is translucent or substantially transparent to allow light to reach the plant and to allow persons to view the condition of the plant.

The apparatus may be formed such that the rod members are substantially flexible, and when no net force is applied thereto, the rod members tend to a straight configuration. In another form, the rod members are substantially rigid, and when no net force is applied thereto, the rod members tend to an arcuate configuration.

The apparatus may also utilize at least one foot operably configured to couple the rod members to the ground surrounding the apparatus.

### BRIEF DESCRIPTION OF THE DRAWINGS

FIG. 1 is a side view of the protective cold frame covering a plant, in one form.

FIG. 2 is a top view of the protective cold frame, in one form.

FIG. 3 is an isometric view of the polymeric cylindrical covering, in one form.

FIG. 4 is a side view of the polymeric cylindrical covering being placed over the frame, in one form.

FIG. 5 is a side view of the polymeric cylindrical covering in place over the frame, in one form.

FIG. 6 is a side view of the polymeric cylindrical covering in place over the frame, with the topmost portion drawn together to close the upper portion of the cylinder, in one form.

FIG. 7 is a side view of the polymeric cylindrical covering in place over the frame, with the topmost portion drawn together to close the upper portion of the cylinder, in one form FIG. 6 and shows optional side tie elements.

FIG. 8 is a detail view of the optional side tie elements shown in FIG. 7, in one form.

FIG. 9 is a top view of the protective cold frame in one form, showing an embodiment with three rod members extending from the coupling device.

FIG. 10 is a top view of the protective cold frame in one form, showing an embodiment with six rod members extending from the coupling device.

FIG. 11 is an isometric view of the protective cold frame in one form, showing an embodiment with four, non cylindrical rod members extending from the coupling device.

FIG. 12 is an isometric view of the protective cold frame in one form, showing an embodiment with four, non-cylindrical rod extension members extending from the coupling device.

FIG. 13 is an isometric view of the protective cold frame in one form, showing an embodiment with horizontal cross members.

FIG. 14 is an assembly view of the protective cold frame in one form, using interchangeable rods.

FIG. 15 is an assembly view of the interchangeable rods of FIG. 14, in one form.

### DESCRIPTION OF THE PREFERRED EMBODIMENTS

Disclosed herein is a plant protecting device which is commonly known as a protective cold frame. While this description seems to indicate a frame-like device, the described device is intended to refer not only to the frame but also to a wind and thermal protective covering generally configured to hold heat therein to protect a plant therein from cold, wind, and the combination. In general, the disclosed device comprises a plurality of rod members that may be bendable, which are inserted into a coupler at the apex of the dome-shaped frame to provide a support structure for a cylindrical covering to be placed thereupon.

In one embodiment, the cylindrical covering is formed of a polymer material, such as thin film plastic, which is very easily formed into cylinders to provide protection from wind as well as heavy rain. It will tend to hold heat within the apparatus when sufficiently sealed, thus protecting the plant therewithin from each of these negative factors. In addition, by utilizing an open cylinder instead of a closed bag or cone, access to the plant is easily achieved as one need only open the constriction point of the cylinder to allow access to the plant within for watering, sun, or other care of the plant without requiring removal of the covering.

By using an embodiment wherein a plurality of rod members are coupled to a central coupling device, the unassembled size of the overall apparatus is quite small, and the assembled apparatus can be configured to be much larger in order to cover plants that are well developed and yet still susceptible to negative factors, such as those described above. In one form, a central opening in the center of the coupling device, allow for use of a plant stake which will provide additional stability to the frame, and to the plant itself which may be attached to and supported by the center stake. The plant (center) stake may be attached to the coupling device 32 or may be allowed to slide relative thereto.

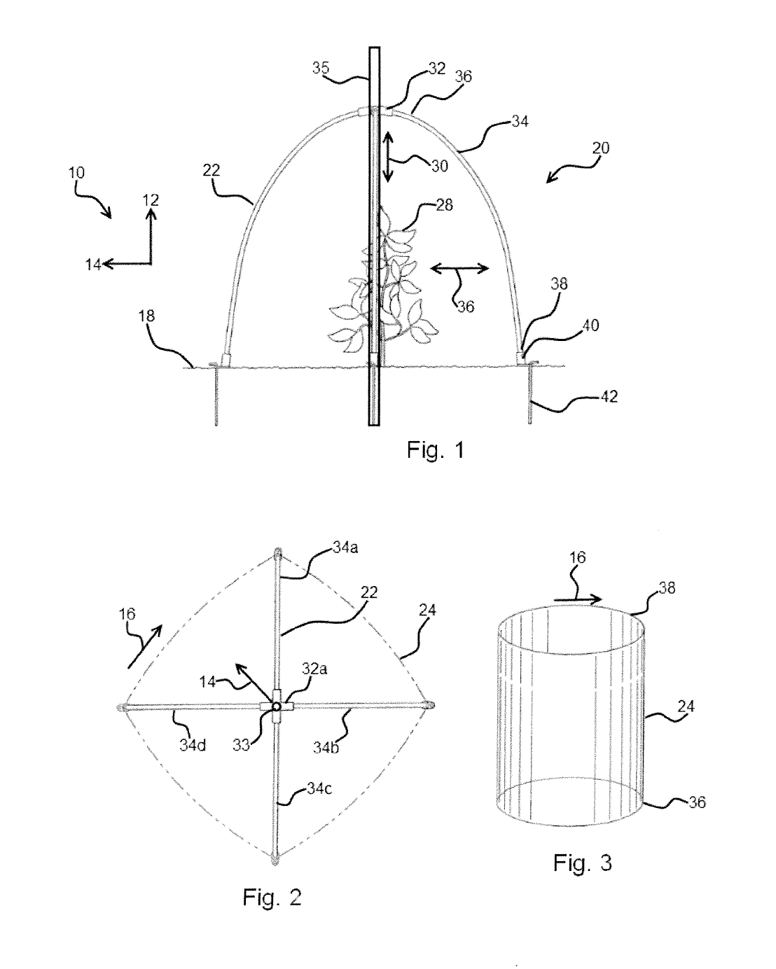

Before beginning a detailed description, an axis system 10 is shown in FIG. 1, comprising a vertical axis 12 generally pointing in an upward direction away from the ground 18, and a radially outward axis 14, which is shown in FIG. 1 but more easily understood by looking at FIG. 2. Additionally, a circumferential direction 16 is shown in FIGS. 2 and 3, which may or may not scribe a circle around the center of the radial axis 14, as will be more understood by reading the remainder of the disclosure.

Looking to FIG. 1, the apparatus 20 comprising the frame 22 is shown prior to attachment of the cylindrical covering 24, as shown in FIG. 3. As shown, there is clearly a gap 6 circumferentially around a plant 28 and the frame 22, as well as a substantial headspace 30 above the plant 28 and the coupling device 32. As shown and clearly evident from the figures, a plurality of rod members 34, each having a first end 36 and a second end 38, is utilized to provide the frame 22. To assemble the structure, the first end 36 is coupled to the coupling device 32, such as by inserting it therein, whereupon the second end 38 may be attached to a foot 40 or may be placed upon or inserted into the ground 18. In some instances, a ground-engaging stake 42 may be provided to further maintain the frame 22 in the proper orientation above the plant 28 even in conditions of moderate wind or impact by animals or people. To add further stability to the apparatus 20, a center stake 35 may be utilized which is inserted through a center opening 33 in the coupling device 32 and into the ground some distance. Plants such as for example Tomatoes and corn may be attached to the stake using known methods, whereas other plants such as vines (peas, beans etc.) will have a natural affinity to attach themselves to the center stake 33.

Looking to FIG. 3, the cylindrical covering 24 is shown in its expanded state, ready to be placed over the frame 22. In one form, the cylindrical covering 24 is formed of a polymer material, such as thin film plastic, which is not only easy to manufacture, but also compresses into a very small shipping and storage space. Thus, once expanded to its full size as shown in FIG. 3, it can be fitted over the frame 22, as shown in FIG. 2. As shown, once in place, the covering 24 reshapes to a more rectilinear shape around each of the rod members 34. In this embodiment, there are four rod members 34a-34d extending from a four pronged coupling device 32a. Thus, the covering 24 would generally reform to a more square shape.

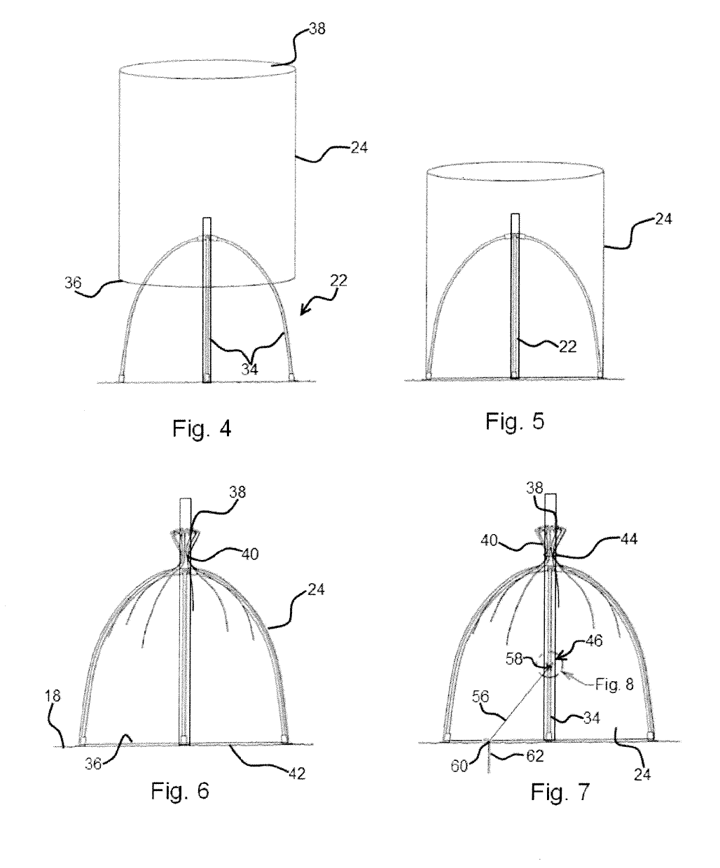

As shown, the covering 24 comprises a first end 36, which is open to the interior and allows the covering 24 to be placed over the frame 22. The covering 24 also comprises a second end 38, which is longitudinally opposite the first end 36. FIG. 4 shows one embodiment wherein the first end 36 of the covering 24 is placed over and around the rod members 34, comprising the frame 22. In this embodiment, the material utilized as the covering 24 is translucent or substantially transparent to allow radiant energy into the center of the apparatus 20 to be utilized by the plant 28, although, it could be possible to utilize an opaque material for other uses. In this embodiment shown in FIG. 4, the second end 38 is open. Looking to FIG. 5, the covering 24 is completely in place over the frame 22 and moving on to FIG. 6, the upper edge or second end 38 is gathered together about a constriction point 40 to enclose the apparatus 20. This could be done very tightly to seal air and heat therein or alternatively could remain slightly loose to allow some heat and humid air out. In one form, a slight air gap 42 may remain between the lower edge or first end 36 of the covering 24 and the surrounding ground 18, or alternatively the apparatus 20 could be configured to form an airtight seal or substantially airtight seal between the covering 24 and the ground 18.

Looking to FIG. 7, it can be seen how once the upper edge 38 is constricted as previously shown in FIG. 6, a string 44 or other attachment apparatus can be placed around the constriction point 40 to hold the upper edge 38 closed. Other attachment mechanisms such as zip ties, wire ties, bread clips, clothespins or similar apparatuses could alternatively be used.

In one embodiment shown in FIG. 7, a plurality of side tie elements 46 can be utilized to attach the covering 24 to the rod members 34. This is shown in more detail in FIG. 8. As shown, a plurality of holes 48 and 50 may be provided in the covering 24, and a string 52 or similar attachment device may be threaded through a first hole 48, around the rod member 34, out through the hole 50, and then tied at the location indicated at 54. These side tie elements 46 would further attach the cylindrical covering 24 to the rod members 34 and may allow for some vertical displacement of the lower edge or first end 36 of the covering 24 in relationship to the ground 18 while still maintaining the cover 24 upon the frame 22.

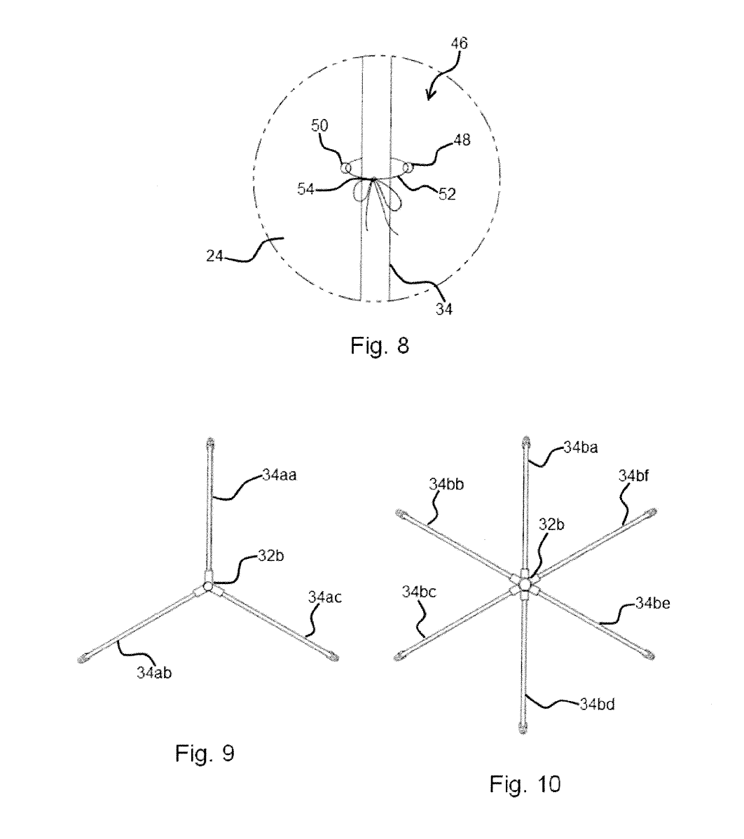

While a first embodiment is shown in FIGS. 1-7 comprising a coupling device 34a having four connector positions to attach to four unique rod members 34, FIG. 9 shows another embodiment 32b which provides for three connector positions to connect three unique rod members 34aa-34ac. Additionally, shown in FIG. 10 is a coupler 32b which allows for six connector positions to attach to six or fewer unique rod members 34. As shown, six rod members 34ba-34bf are attached to the coupler 32b, forming the frame 22. However, some of the rod members could be omitted; for example, every other rod member could be omitted and the end of frame member would be more similar to the embodiment shown in FIG. 9, with three of the coupler positions not being utilized. Someone of ordinary skill in the art would be able to understand this concept and decide upon the appropriate number of rod members to be utilized. Similarly, one of ordinary skill in the art could easily see that additional combinations could be utilized from three rod members, as shown in FIG. 9, with no theoretical limit to the upper number of rod members that could be utilized. However, it would be more difficult to form a coupler 32 with a larger number of rod members.

Looking to FIG. 7, at least one guy line 56 may be provided to further increase the wind resistance of the apparatus 20. The guy line 56 may be attached at a first end 58 to the side tie elements 46, and attached at a second end 60 to an outer ground-engaging stake 62. Working tests have shown that this apparatus can protect plants in sustained winds of 50 mph.

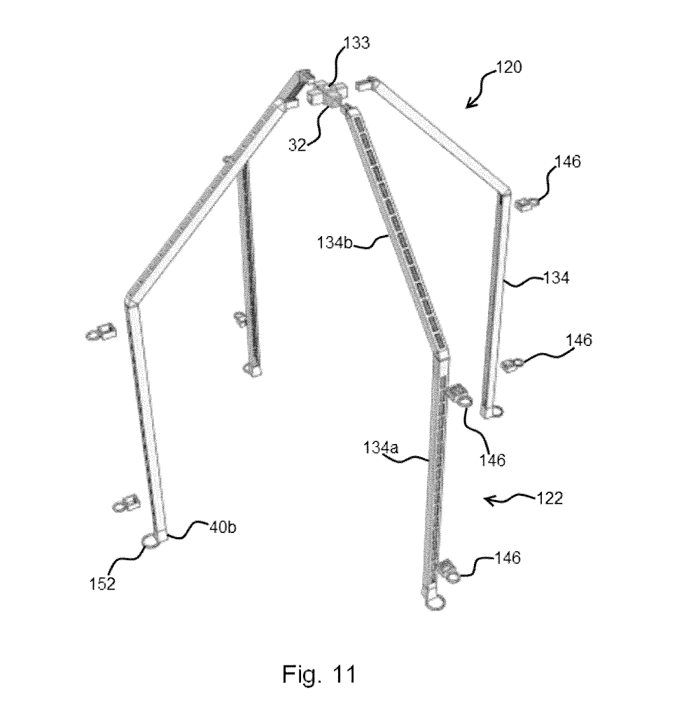

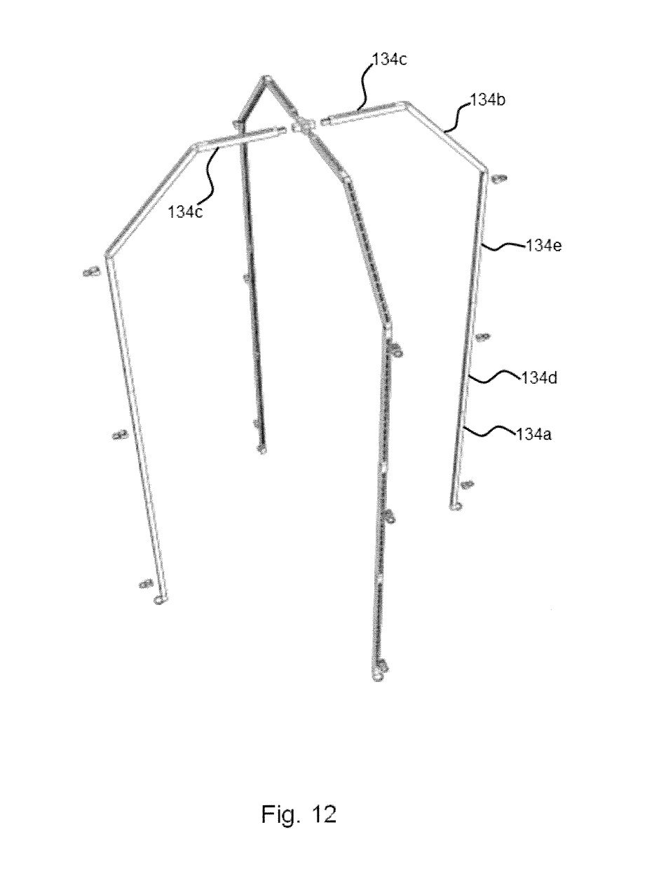

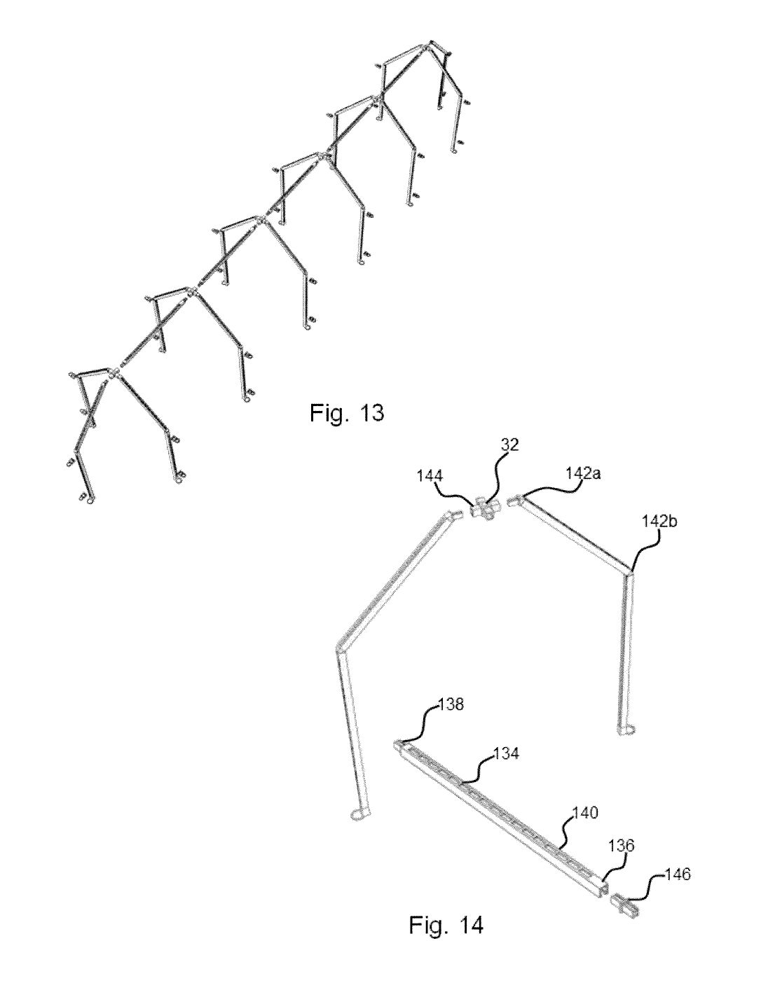

While the above embodiments show a device designed on elements substantially having a round cross section, the embodiments 120 shown in FIGS. 11 and 12 have a generally square or I-shaped cross section, such as the interchangeable rod members 134. In this embodiment, the frame 122 comprises interchangeable rod members being used as lower rod members 134a and upper rod members 134b. If a wider apparatus 120 is desired, expansion rod members 134c can be utilized, as shown in FIG. 12. If a taller apparatus is desired, as shown in FIG. 12, additional vertical members 134d and optionally 134e can be utilized. In one form, each interchangeable rod 134, as shown in FIG. 14, comprises an integral female coupler 136, and/or a male coupler 138 with a central portion 140 therebetween. In this embodiment, the top coupling device 32 may comprise female couplers 144, substantially identical to the female couplers 136 and configured to receive the male couplers 138 on the end of the interchangeable rods 134 to form the embodiments shown in FIGS. 12 and 13. For the embodiment shown in FIG. 13, a male/male coupler 146 may be required to couple two female couplers 136/144 together to allow the use of multiple leg assemblies to form a tunnel-like assembly.

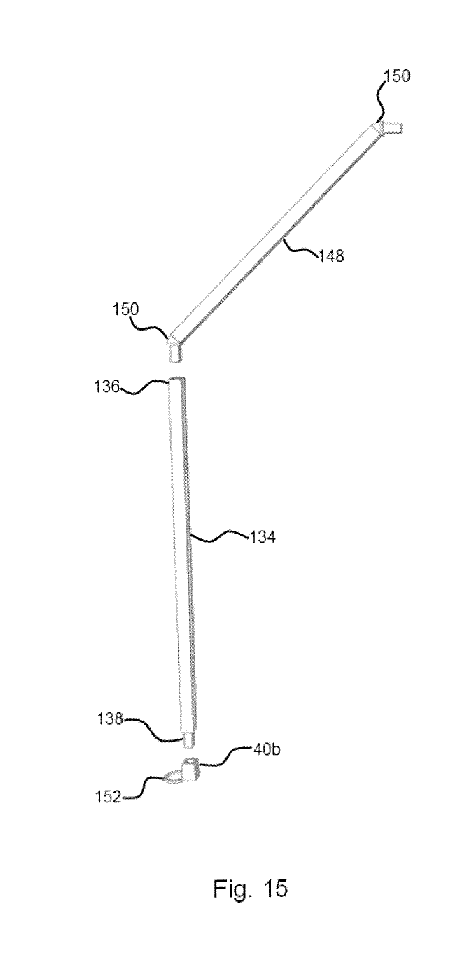

In one form, angle connectors 142 may be utilized having a male/male, female/female, or male/female couplers. In another form, as shown in FIG. 15, each leg of the apparatus comprises one interchangeable rod 134 as previously described, and one angle rod 148, which as shown has angles portions 150 at either end, and male couplers 150 at the extreme ends, which in this embodiment couple to female couplers 144 and 136 on the center coupling device 32 and interchangeable rod 134 respectively. Also as shown, the foot members 40b comprise a female coupler to receive the male end 138 of a interchangeable rod 134 or for very short embodiments, a male connector 150 of an angle rod 148. A ring 152 may also be provided, through which the ground engaging stakes 42 may pass to hold the frame down and in place.

In one form, the center opening 133 of the top coupling device 32 is square in cross section. The center stake (not shown) could be any cross section, as long as its outer diameter is small enough to fit within the center opening 133.

Additionally, the side tie elements 146 are formed more as clips than the string-like elements shown in FIG. 8, but they still maintain a ring-like portion for the attaching of guy lines 56, as previously described.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A frame and covering apparatus to protect plants from cold, the apparatus comprising:
a. a plurality of at least three rod members each having a first longitudinal end configured to engage the ground adjacent a plant to be protected and a second end;
b. at least one coupling device operably configured to engage and receive each of the second ends of the plurality of rod members;
c. each coupling device further having a central opening substantially orthogonal to the second ends of the plurality of rod members;
d. wherein the plurality of rod members form a dome shaped frame when attached to the coupling device and engaged into the ground;
e. a central stake having a first end operatively to engage the ground and a median portion passing through the central opening of the coupling device;
f. a polymeric cylindrical covering having a first end which is open to allow access to the interior of the cylindrical covering;
g. wherein the first end of the cylindrical covering is configured to fit over the dome outline; and
h. wherein the cylindrical covering comprises a second end, longitudinally opposed to the first end, wherein the second end is configured to be gathered together and thus substantially conform the cylindrical covering to the dome shaped frame.

2. The apparatus as recited in claim 1 further comprising a plurality of ground engaging stakes configured to couple to the first ends of the rod members and fixedly and removably engage the ground.

3. The apparatus as recited in claim 2 further comprising at least three foot members operably configured to couple the first ends of the rod members to the ground engaging stakes.

4. The apparatus as recited in claim 1 further comprising:
a. a plurality of side tie elements;
b. wherein a plurality of attachment points are provided on the cylindrical covering between the first end and the second end; and
c. wherein the side tie elements are operably configured to attach the cylindrical covering to the rod members at each of the attachment points.

5. The apparatus as recited in claim 4 further comprising:
a. at least one outer ground engaging stake; and
b. a guy line having a first end coupled to the attachment points of the apparatus; and
c. a second end coupled to the outer ground engaging stakes.

6. The apparatus as recited in claim 1 wherein the covering is translucent.

7. The apparatus as recited in claim 6 wherein the covering is substantially transparent.

8. The apparatus as recited in claim 1 wherein the rod members are substantially flexible and when no net force is applied thereto, the rod members tend to a straight configuration.

9. The apparatus as recited in claim 1 wherein the rod members are substantially rigid, and when no net force is applied thereto, the rod members tend to an arcuate configuration.

10. The apparatus as recited in claim 1 further comprising at least one foot operably configured to couple the rod members to ground surrounding the apparatus.

11. A frame and covering apparatus to protect plants from cold, the apparatus comprising:
a. a plurality of at least three vertically oriented interchangeable rod members each having a first longitudinal end configured to be adjacent the ground adjacent the plant to be protected
b. at least one angled coupling device operably configured to engage and receive each of the second ends of each vertically oriented interchangeable rod member;
c. a plurality of at least three angularly oriented interchangeable rod members each having a first longitudinal end configured to engage the second end of an associated vertically oriented interchangeable rod members;
d. at least one central coupling device further having a central opening substantially orthogonal to the second ends of the plurality of rod members;
e. wherein the plurality of rod members form a dome shaped frame when attached to the central coupling device and engaged into the ground; and
f. wherein the covering is configured to fit over the dome outline.

12. The frame and covering apparatus as disclosed in claim 11 wherein the angularly oriented interchangeable rod members are of a different end configuration than the vertically oriented interchangeable rod members.

13. The frame and covering apparatus as disclosed in claim 11 further comprising at least one horizontally oriented interchangeable rod member.

14. The frame and covering apparatus as disclosed in claim 11 further comprising a foot member configured to couple to first longitudinal end of each vertically oriented interchangeable rod members which are configured to be adjacent the ground adjacent the plant to be protected.
